(19) United States
(12) Patent Application Publication
(10) Pub. No.: US 2026/0318935 A1
(43) Pub. Date: Oct. 15, 2026

(54) FULLY AUTOMATIC TESTING APPARATUS

(71) Applicant: Hai Kang Life Corporation Limited, Hong Kong (CN)

(72) Inventor: Cheung Hoi YU, Hong Kong (CN)

(21) Appl. No.: 19/647,212

(22) Filed: Apr. 14, 2026

(30) Foreign Application Priority Data
Apr. 14, 2025 (HK) 320251060309
Apr. 14, 2025 (HK) 320251060317

(51) Int. Cl. G01N 35/00

(52) U.S. Cl. CPC G01N 35/00584; G01N 2035/00376

(57) ABSTRACT

The present disclosure discloses a fully automatic testing apparatus, comprising: a tray assembly, configured to carry a kit, wherein the kit comprises a reaction zone and a chip zone, the reaction zone is configured to perform amplification and obtain an amplification product, and the chip zone is configured to detect the amplification product; pressing assemblies, two of the pressing assemblies being correspondingly distributed on two sides of the tray assembly, configured to press two sides of the kit against the tray assembly; a first temperature control assembly, floatingly disposed in the tray assembly, configured to control the temperature of the reaction zone; a second temperature control assembly, floatingly disposed in the tray assembly, configured to control the temperature of the chip zone; an image processing assembly, located above the pressing assembly adjacent to the chip zone, configured to acquire and analyze the detection results of the chip zone. The fully automatic testing apparatus of the present disclosure improves the temperature control effect, ensures the reaction accuracy and detection accuracy, and has a more compact overall structure.

The present disclosure claims priority to Hong Kong, China patent application No. HK32025106031.7, entitled “A Fully Automatic In Vitro Testing Instrument and Kit Integrated System Thereof”, filed on Apr. 14, 2025, and Hong Kong, China patent application No. HK32025106030.9, entitled “An Integrated DNA Automatic Amplification and Detection Cartridge device Integrating Pre-loaded Reagents and Nucleic Acid Hybridization Chip”, filed on Apr. 14, 2025, the entire contents of each of which are incorporated herein by reference.

### TECHNICAL FIELD

The present disclosure pertains to the technical field of biological testing devices, and specifically relates to a fully automatic testing apparatus that integrates PCR amplification, temperature control management, automated reagent transfer and image analysis.

### BACKGROUND

Conventional testing typically requires the use of separate instruments for PCR amplification and biochip incubation respectively, and the reaction tubes after PCR amplification must be manually transferred to a chip reader or a hybridization instrument. Such step-by-step operation not only increases operational delay, but also the process of opening the cap for transfer is highly prone to causing aerosol leakage, leading to laboratory cross-contamination and false positive results.

Existing biochip platforms mostly rely on ambient temperature control or simple passive heating, and the degree of fit between the temperature control module and the kit is insufficient, resulting in inaccurate temperature control, large temperature fluctuations and uneven temperature distribution, thereby affecting the hybridization kinetics and enzyme reaction efficiency and reducing the detection sensitivity and reproducibility. Meanwhile, existing biochip platforms are relatively large in overall volume and are not sufficiently compact in structure.

### SUMMARY

In view of this, in order to overcome the defects of the prior art, an object of the present disclosure is to provide an improved fully automatic testing apparatus, which has a more compact structure and more precise temperature control.

In order to achieve the above object, the present disclosure adopts the following technical solutions:
A fully automatic testing apparatus, comprises:
a tray assembly, configured to carry a kit, wherein the kit comprises a reaction zone and a chip zone, the reaction zone is configured to perform amplification and obtain an amplification product, and the chip zone is configured to detect the amplification product;
pressing assemblies, two of the pressing assemblies being correspondingly distributed on two sides of the tray assembly, configured to press two sides of the kit against the tray assembly; each of the pressing assemblies comprises a fixed seat, a pressing block and a first driver, wherein one end of the pressing block is rotatably disposed on the fixed seat, the other end of the pressing block is configured to act on the kit, and the first driver is configured to drive the pressing block to rotate around the fixed seat;
a first temperature control assembly, floatingly disposed in the tray assembly, configured to control the temperature of the reaction zone;
a second temperature control assembly, floatingly disposed in the tray assembly, configured to control the temperature of the chip zone; and
an image processing assembly, located above the pressing assembly adjacent to the chip zone, configured to acquire and analyze the detection results of the chip zone.

Further, the reaction zone of the kit comprises a first chamber for storing reagents, a second chamber for storing a sample, and a third chamber for providing a reaction site; the chip zone of the kit comprises a fourth chamber for detection and a fifth chamber for receiving waste liquid after detection, a discharge tube is disposed between the fourth chamber and the fifth chamber, and an isolation hole is disposed on a side edge of the kit corresponding to the discharge tube; the fully automatic testing apparatus comprises an isolation assembly disposed corresponding to the isolation hole, configured to extend into the isolation hole and squeeze the discharge tube so as to close the passage between the fourth chamber and the fifth chamber.

Further, the isolation assembly comprises a connecting block, an insertion head, and a second driver for driving the insertion head and the connecting block to move, wherein the insertion head and the second driver are respectively disposed on two sides of the connecting block, the insertion head is configured to be inserted into the isolation hole to squeeze the discharge tube, the connecting block is configured in an annular shape, and a driving rod of the first driver passes through the connecting block. The shape of the insertion head is configured corresponding to the isolation hole. The cross-arrangement of the pressing assembly and the isolation assembly makes the structure more compact. The isolation assembly is also disposed directly below the image processing assembly.

Further, the tray assembly comprises a tray and a bottom box, the tray covers the bottom box, the first temperature control assembly and the second temperature control assembly are disposed in the bottom box, and the tops of the first temperature control assembly and the second temperature control assembly pass through the tray and are respectively configured to contact the reaction zone and the chip zone of the kit, wherein the bottom of the chip zone has a silicon-based thermally conductive layer for contacting the second temperature control assembly.

Further, a rod member extending toward the bottom box is disposed on the tray, the first temperature control assembly or the second temperature control assembly is disposed on the rod member, a limiting member is disposed at the bottom of the rod member, an elastic member is sleeved on the rod member, one end of the elastic member acts on the first temperature control assembly or the second temperature control assembly, and the other end of the elastic member acts on the limiting member. The above structure enables both the first temperature control assembly and the second temperature control assembly to be floatingly disposed on the tray, and there is no connection structure between the first temperature control assembly and the second temperature control assembly, which act independently and can better fit with the bottom of the kit.

Further, the kit comprises a rotary valve, the rotary valve comprises a valve disc and a valve barrel extending upward from the valve disc, a receiving cavity is defined in the valve barrel, and a plunger is disposed in the receiving cavity; the fully automatic testing apparatus comprises a clamping assembly for clamping the plunger and driving the plunger to move, and a rotation assembly for clamping the valve barrel and driving the valve barrel and the valve disc to rotate.

Further, the clamping assembly comprises a clamping jaw and a first driving assembly for driving the clamping jaw to bring the plunger to move; the rotation assembly comprises a sleeve and a second driving assembly for driving the sleeve to rotate, wherein the sleeve is configured to be sleeved on the valve barrel.

Further, the kit comprises a base, the base being configured to contact the first temperature control assembly; the third chamber is disposed in the base, a sealing film is disposed on the bottom surface of the base corresponding to the third chamber, and the sealing film is configured to seal the bottom of the third chamber.

Further, a round hole is defined in a center of the base and in a center of the sealing film, an annular protrusion extending toward the interior of the round hole is provided on the inner wall of the round hole, the first temperature control assembly comprises a heating block, the heating block comprises a first extension portion extending into the round hole and reaching the annular protrusion and a step portion located below the annular protrusion, the first extension portion and the step portion contact the inner wall of the round hole, and the top of the first extension portion is higher than the annular protrusion.

Further, an annular groove is provided at the bottom of the base outside the third chamber, the heating block comprises a second extension portion extending into the annular groove, and the second extension portion contacts the inner wall of the annular groove.

Further, the fully automatic testing apparatus comprises a housing, a control assembly and a screen disposed on the housing, wherein the housing has an opening for allowing the tray assembly to move out of the housing, and the housing comprises a cover plate covering the opening; the control assembly is connected with the screen and each assembly, and the screen is operated to control the action of each assembly through the control assembly.

Owing to the adoption of the above technical solutions, compared with the prior art, the beneficial effects of the present disclosure are as follows: in the fully automatic testing apparatus of the present disclosure, the two pressing assemblies are correspondingly distributed on two sides of the tray assembly and act on the four corners of the kit, so that the force applied and the force received are more uniform, and the fit between the kit and the tray is closer; meanwhile, the first temperature control assembly corresponding to the reaction zone and the second temperature control assembly corresponding to the chip zone are independently and floatingly disposed on the tray assembly, so that the first temperature control assembly and the reaction zone, and the second temperature control assembly and the chip zone can more closely fit and act, improving the temperature control effect and ensuring the reaction accuracy and detection accuracy; the two independent pressing assemblies and the independent floating temperature control assemblies can be applied to kits of different specifications while ensuring the pressing and temperature control effects; the image processing assembly is located directly above one of the pressing assemblies, making the overall structure more compact.

### BRIEF DESCRIPTION OF THE DRAWINGS

FIG. 1 is a schematic perspective structural diagram of a fully automatic testing apparatus in an embodiment of the present disclosure;

FIG. 2 is a schematic perspective structural diagram of the interior of the fully automatic testing apparatus with the housing hidden in an embodiment of the present disclosure;

FIG. 3 is a schematic perspective structural diagram after the tray assembly, the conveying assembly, the pressing assembly, the isolation assembly, the first temperature control assembly and the second temperature control assembly are assembled in an embodiment of the present disclosure;

FIG. 4 is a schematic cross-sectional structural diagram after the tray assembly, the first temperature control assembly and the second temperature control assembly are assembled in an embodiment of the present disclosure;

FIG. 5 is a schematic perspective structural diagram of the clamping assembly and the rotation assembly in an embodiment of the present disclosure;

FIG. 6 is a schematic perspective structural diagram of the image processing assembly in an embodiment of the present disclosure;

FIG. 7 and FIG. 8 are schematic perspective structural diagrams of the kit at different viewing angles in an embodiment of the present disclosure, respectively;

FIG. 9 is a schematic perspective structural diagram of the kit with the cover hidden in an embodiment of the present disclosure;

FIG. 10 is a schematic top structural view of the kit with the cover hidden in an embodiment of the present disclosure;

FIG. 11 is a schematic cross-sectional structural view along A-A in FIG. 10;

FIG. 12 is a schematic front structural view of the communication tube in an embodiment of the present disclosure;

FIG. 13 and FIG. 14 are schematic perspective structural diagrams of the base at different viewing angles in an embodiment of the present disclosure, respectively;

FIG. 15 is a schematic top structural view of the base in an embodiment of the present disclosure;

FIG. 16 is a schematic cross-sectional structural view along B-B in FIG. 15;

FIG. 17 is a schematic cross-sectional structural view after the base and the heating block are assembled in an embodiment of the present disclosure;

FIG. 18 is a schematic perspective structural diagram of the rotary valve in an embodiment of the present disclosure;

FIG. 19 is a schematic top structural view of the rotary valve in an embodiment of the present disclosure;

FIG. 20 is a schematic cross-sectional structural view along C-C in FIG. 19;

In the drawings, reference signs include: main body 1, first cover 21, second cover 22, hollow module 3, hollow region 31, first chamber 32, second chamber 33, third chamber 34, third chamber inlet 341, third chamber outlet 342, rotary valve 5, valve disc 51, valve barrel 52, receiving cavity 53, plunger 54, valve inlet 55, valve outlet 56, exhaust passage 57, communication hole 61, communication tube 62, first segment 71, second segment 72, third segment 73, base 8, round hole 81, annular groove 82, annular protrusion 83, detection assembly 9, detection chip 91, fourth chamber 92, fifth chamber 10, sealing film 11, communication flow passage 12, kit 13, isolation hole 131, heating block 14, first extension portion 141, second extension portion 142, step portion 143, discharge tube 15, frame 16, conveying assembly 20, tray assembly 201, tray 2011, bottom box 2012, chip interface 202, first temperature control assembly 203, reaction zone thermally conductive block 2030, reaction zone semiconductor cooler 2031, water cooling radiator 2032, water cooling radiator bottom plate 2033, second temperature control assembly 204, chip zone thermally conductive block 2040, chip zone semiconductor cooler 2041, air cooling radiator 2042, rod member 2050, elastic member 2051, limiting member 2052, pressing assembly 210, first micro push rod 211, first pressing block 212, second micro push rod 213, second pressing block 214, second driver 215, connecting block 216, insertion head 217, isolation assembly 218, fixed seat 219, eighth stepping motor 221, eighth screw rod 222, eighth slider 223, first slide rail 225, second slide rail 226, clamping assembly 30, first motor 301, first screw 302, first slider 303, electric clamping jaw 304, second motor 311, second screw 312, second slider 313, rotation assembly 320, third motor 321, mounting bracket 322, rotating hollow shaft 323, sleeve 324, laser sensor 3252, fourth motor 331, fourth screw rod 332, fourth slider 333, image processing assembly 50, industrial camera 501, light source 502, optical magnification objective lens 504, coaxial optical path 503, fifth motor 511, fifth slider 512, sixth motor 521, sixth slider 522, seventh motor 531, seventh slider 532, housing 601, opening 602, screen 603, cover plate 604.

### DETAILED DESCRIPTION

The technical solutions of the present disclosure are further described below with reference to the accompanying drawings and preferred embodiments.

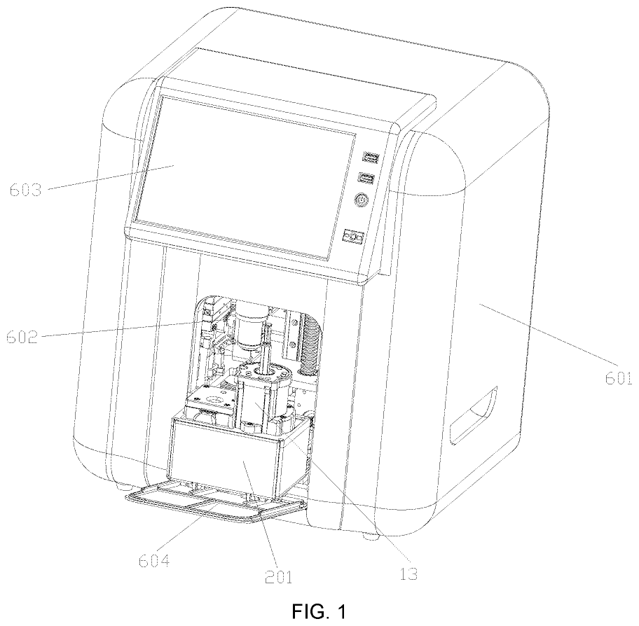

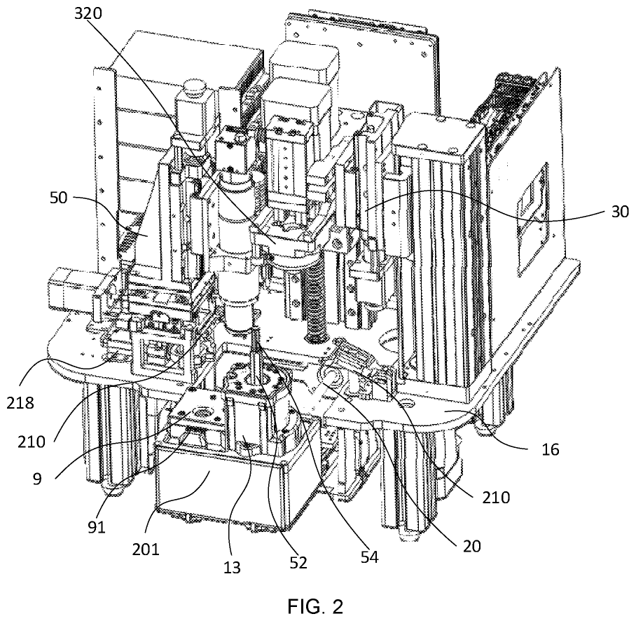

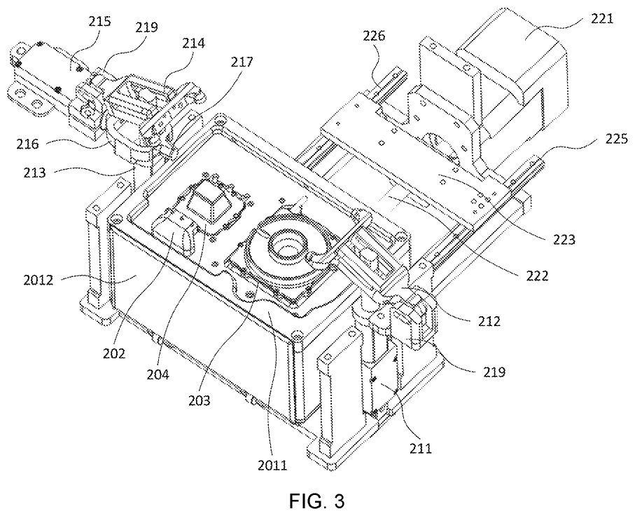

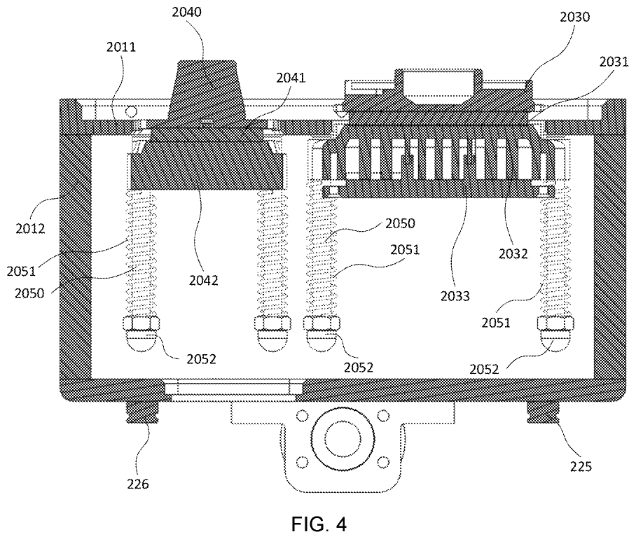

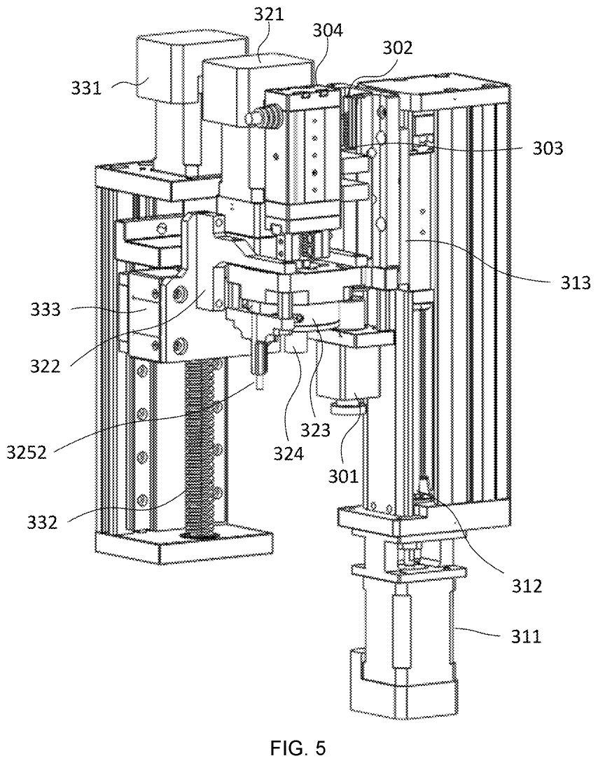

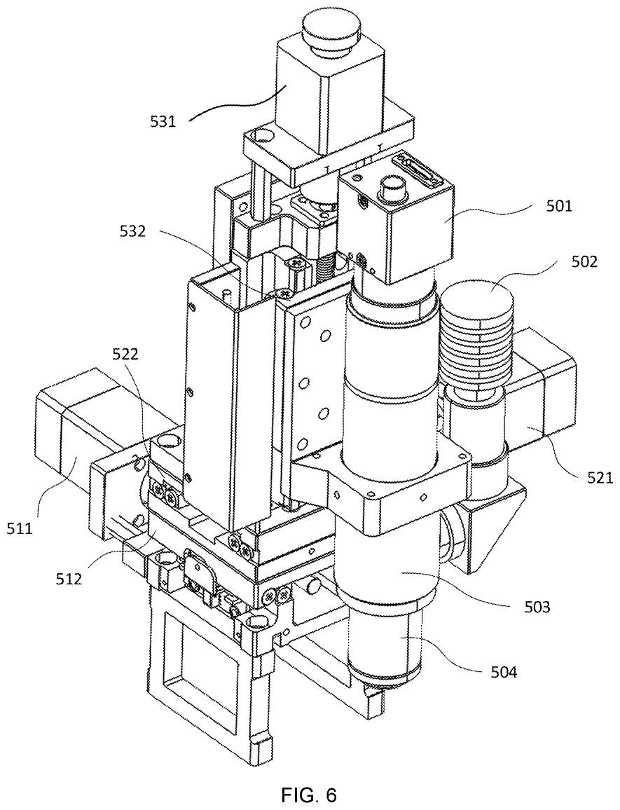

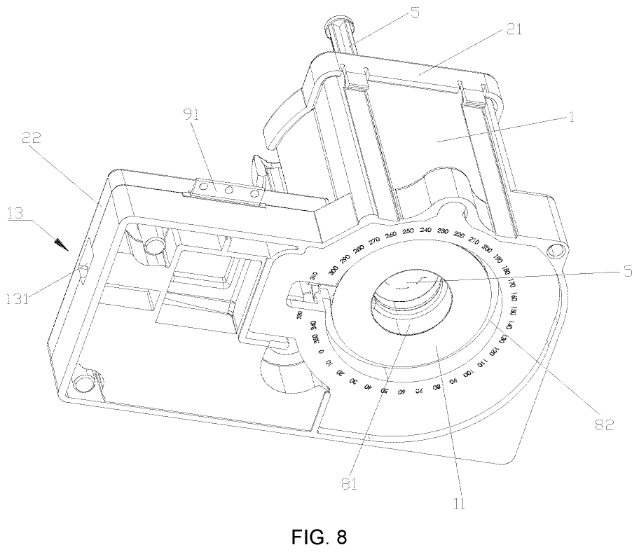

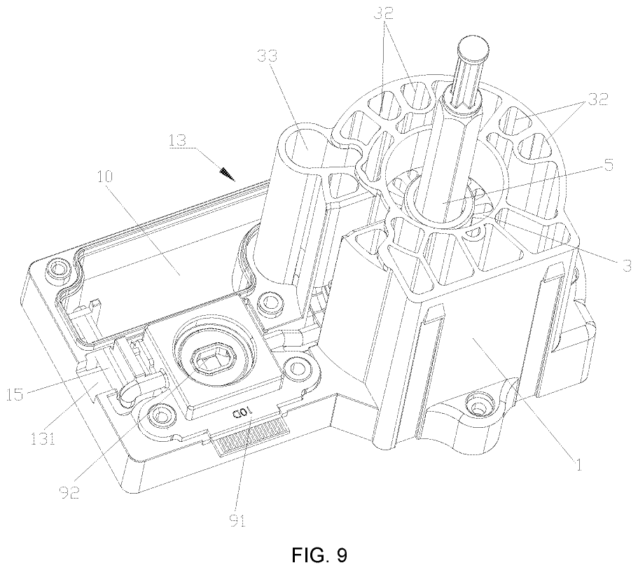

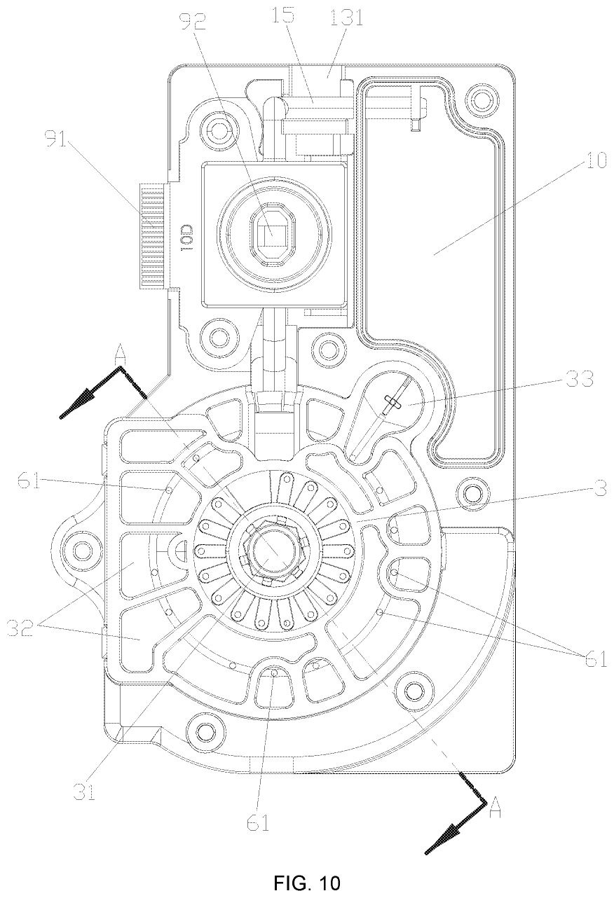

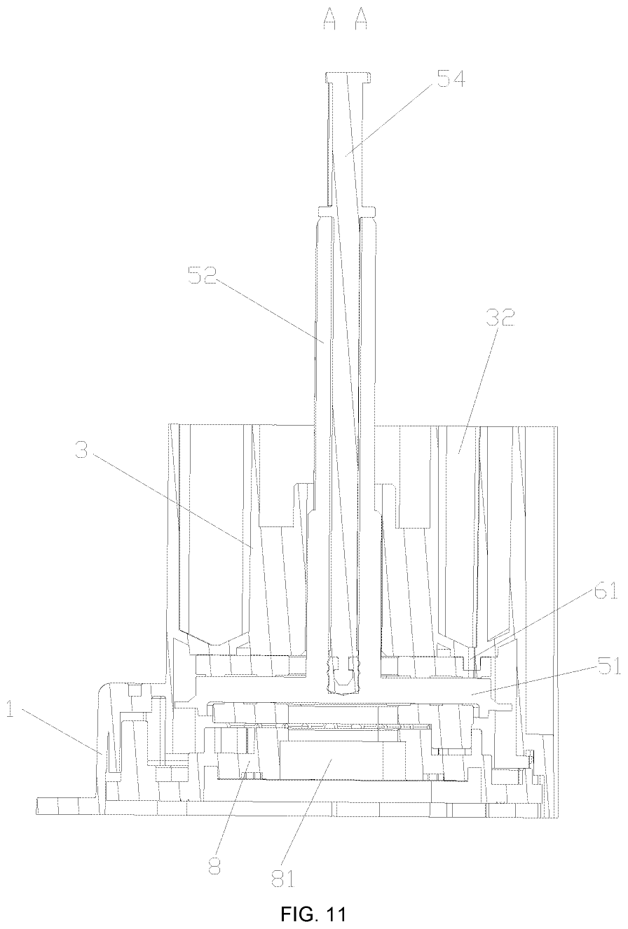

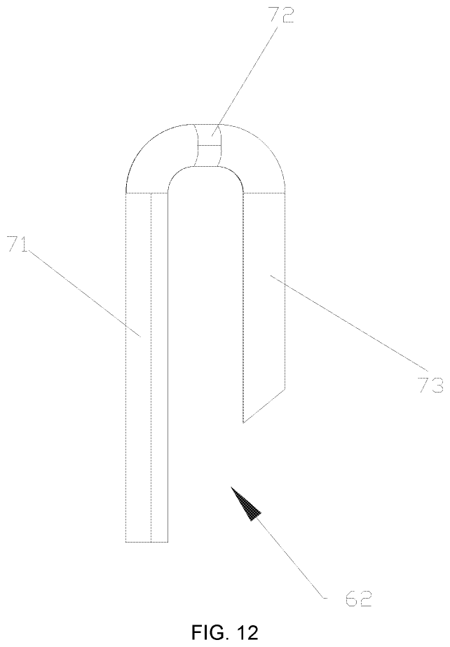

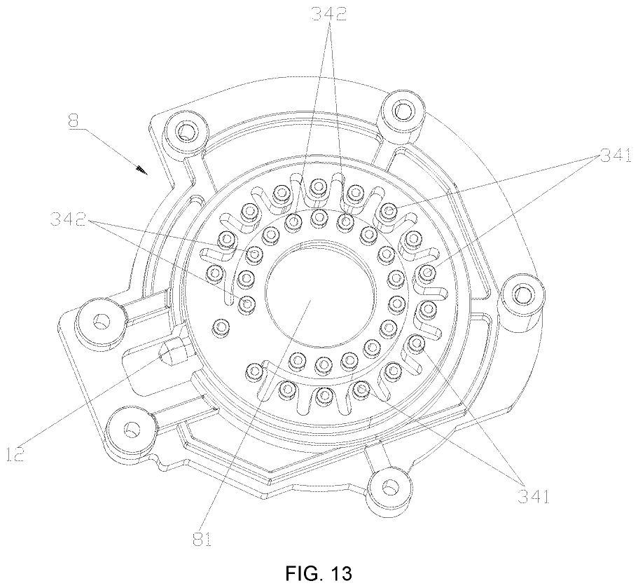

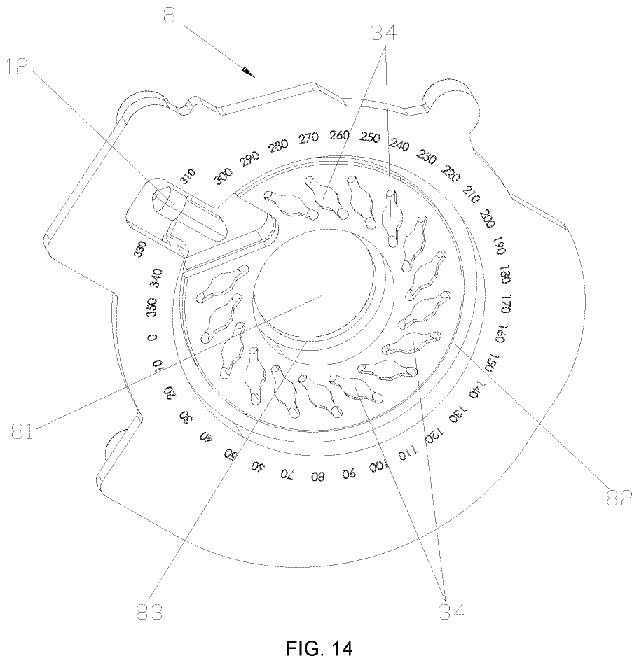

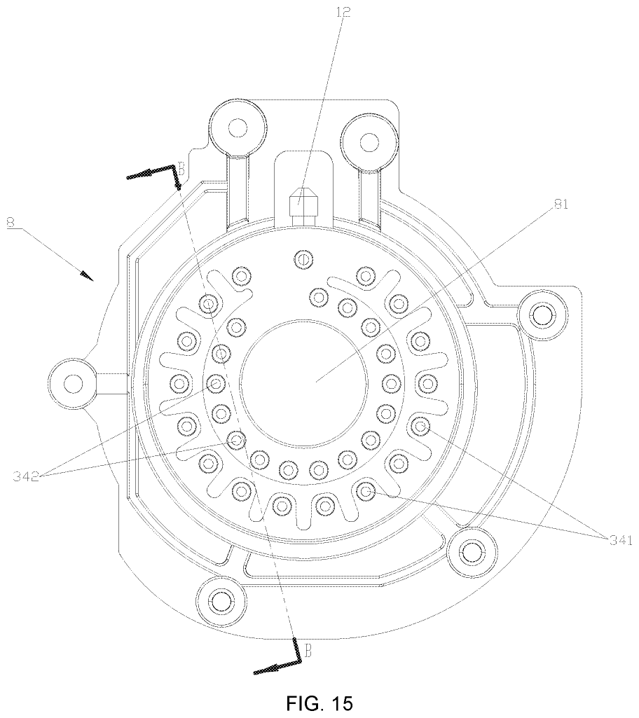

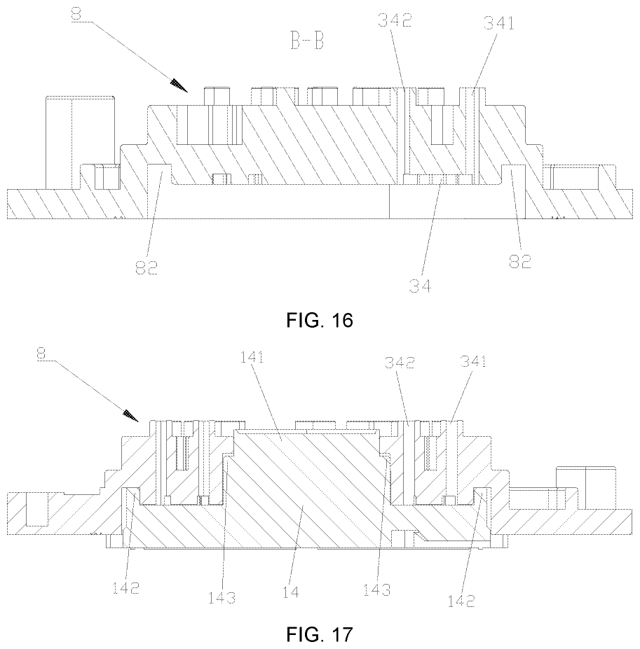

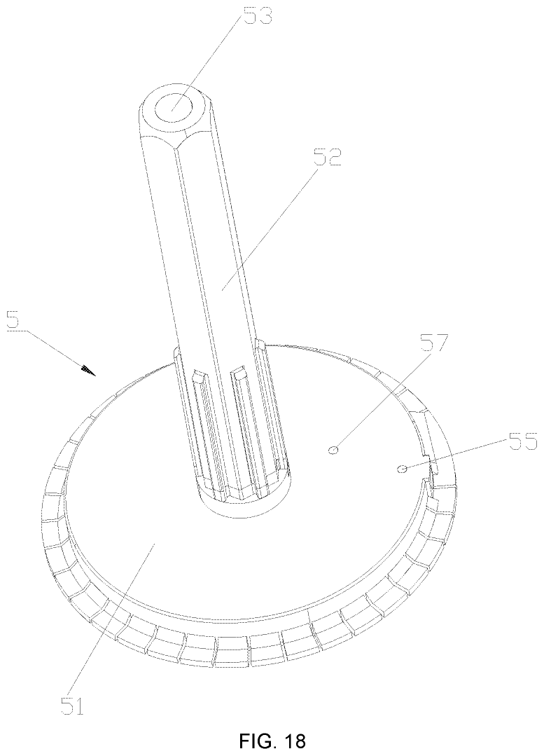

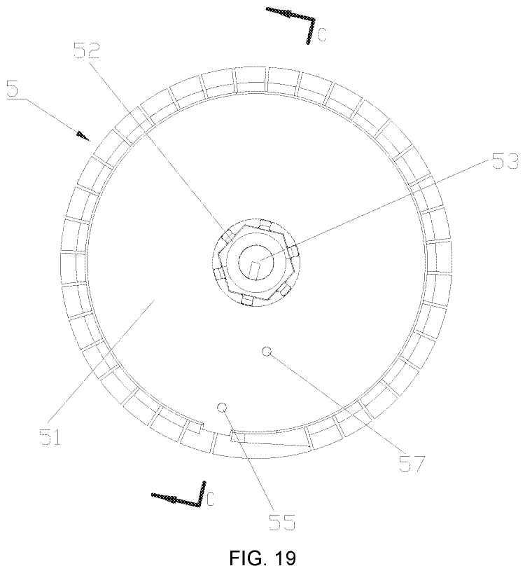

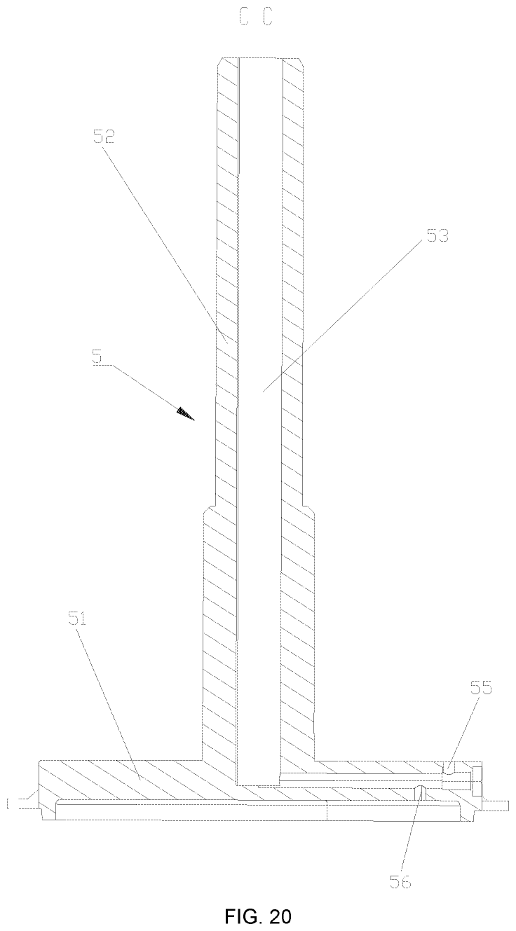

As shown in FIG. 1 to FIG. 20, the fully automatic testing apparatus in this embodiment comprises a control assembly, a housing 601, a frame 16 disposed in the housing 601, and a tray assembly 201, a pressing assembly 210, a first temperature control assembly 203, a second temperature control assembly 204, an image processing assembly 50, a conveying assembly 20, a clamping assembly 30 and a rotation assembly 320 disposed on the frame 16. The housing 601 has an opening 602 for allowing the tray assembly 201 to move out of the housing 601, the housing 601 comprises a cover plate 604 covering the opening 602, and the cover plate 604 is rotatably disposed on the housing 601; when the tray assembly 201 is located inside the housing 601, the cover plate 604 covers the opening 602. A screen 603 is disposed on the housing 601, the control assembly is connected with the screen 603 and each assembly, and the screen 603 is operated to control the action of each assembly through the control assembly. The function of each assembly is as follows:
the tray assembly 201 is configured to carry the kit 13 and to provide support for the first temperature control assembly 203 and the second temperature control assembly 204, and can convey the kit 13 into the interior of the apparatus and fix it;
the pressing assemblies 210, two of the pressing assemblies 210 being correspondingly distributed on two sides of the conveying assembly 20, are configured to press two sides of the kit 13 against the tray assembly 201;
the clamping assembly 30 and the rotation assembly 320 act on the kit 13 to control the flow or reaction of substances inside the kit 13;
the first temperature control assembly 203, floatingly disposed in the tray assembly 201, is configured to control the temperature of the reaction zone;
the second temperature control assembly 204, floatingly disposed in the tray assembly 201, is configured to control the temperature of the chip zone;
the image processing assembly 50, located above the pressing assembly 210 adjacent to the chip zone, is configured to acquire and analyze the detection results of the chip zone;
the conveying assembly 20 is configured to drive the tray assembly 201 into and out of the housing 601 through the opening 602, in order to receive the kit 13 for detection, or to feed the kit 13 out after the detection is completed.

The frame 16 in this embodiment comprises a horizontally disposed fixed plate, on which the pressing assembly 210, the clamping assembly 30, the rotation assembly 320, the conveying assembly 20, the image processing assembly 50, etc. are fixed, and the conveying assembly 20 is disposed below the fixed plate, while the remaining assemblies are disposed above the fixed plate. The top surface of the tray assembly 201 is horizontally arranged with the fixed plate, a notch is defined on a side of the fixed plate close to the opening of the housing for accommodating the tray assembly, and the two pressing assemblies 210 are disposed on two sides of the notch. The overall structure of the apparatus is more stable, and the space is more compact.

A detailed structural description of the kit 13 corresponding to the fully automatic testing apparatus in this embodiment is given below, so as to better understand the structure and action process of the fully automatic testing apparatus.

The kit 13 comprises a reaction zone and a chip zone, wherein the reaction zone is configured to perform amplification and obtain an amplification product, and the chip zone is configured to detect the amplification product.

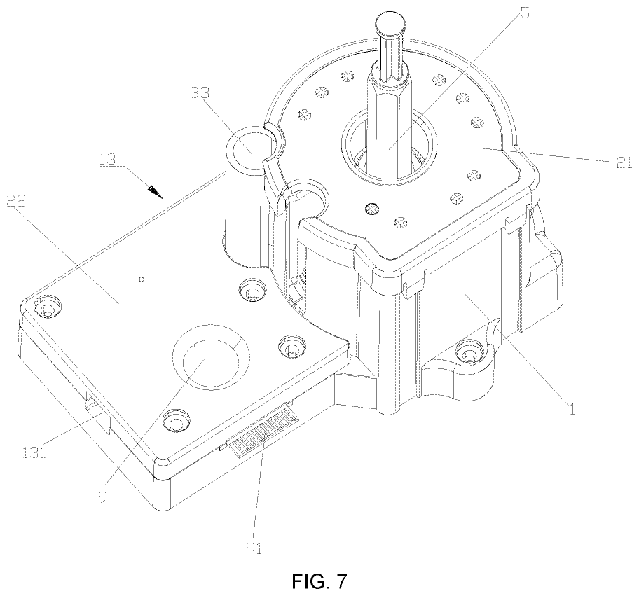

Specifically, as shown in FIG. 7 to FIG. 20, the kit 13 of this embodiment, which is used for automated reaction and detection of multiplex PCR, comprises a main body 1, a first cover 21, a second cover 22, a detection assembly 9, a base 8 and a rotary valve 5. The main body 1 comprises a hollow module 3, the first cover 21 is disposed above the hollow module 3, and the base 8 is disposed below the hollow module 3. The detection assembly 9 is disposed on the main body 1, the first cover 21 covers the detection assembly 9, and a fifth chamber 10 for receiving waste liquid after detection is further disposed on the main body 1 corresponding to the detection assembly 9. The detection assembly 9 comprises a fourth chamber 92 and a detection chip 91, a discharge tube 15 is disposed between the fourth chamber 92 and the fifth chamber 10, and is made of flexible material. The detection chip 91 has predetermined reaction sites configured for capturing an expected complementary target DNA fragment through capture fragment base sequences (capture probes).

In order to facilitate detection and isolate the waste liquid from the substance to be detected, an isolation hole 131 is disposed on a side edge of the kit 13 corresponding to the discharge tube 15, and the discharge tube 15 is squeezed through the isolation hole 131 so as to close the passage between the fourth chamber 92 and the fifth chamber 10.

The hollow module 3 comprises a hollow region 31 located at the center and a first chamber 32 and a second chamber 33 located at the periphery of the hollow region 31, wherein the second chamber 33 is configured to store a sample, and the first chamber 32 is configured to store reagents. The rotary valve 5 is disposed corresponding to the hollow region 31, and is configured to drive the sample and/or the reagents to transfer within the chambers (the first chamber 32, the second chamber 33, the third chamber 34, the fourth chamber 92, the fifth chamber 10).

A third chamber 34 for providing a reaction site is disposed in the base 8. A sealing film 11 is disposed on the bottom surface of the base 8 corresponding to the third chamber 34, the sealing film 11 being configured to seal the bottom of the third chamber 34; the base 8 is configured to contact the first temperature control assembly 203 to accelerate the reaction. When the kit 13 is in use, the base 8 and the third chamber 34 are heated to accelerate the reaction (amplification) of the substances in the third chamber 34. A communication flow passage 12 for communicating with the detection assembly 9 is further disposed on the base 8 to send the substance to be detected (the amplification product) to the fourth chamber 92 in the detection assembly 9 for detection.

A round hole 81 corresponding to the lower side of the hollow region 31 is defined in a center of the base 8 and in a center of the sealing film 11, an annular protrusion 83 extending toward the interior of the round hole 81 is provided on the inner wall of the round hole 81, and at the same time, an annular groove 82 is provided at the bottom of the base 8 outside the third chamber 34. The round hole 81, the annular protrusion 83 and the annular groove 82 are configured to cooperate with the first temperature control assembly 203 of the fully automatic testing apparatus.

The rotary valve 5 comprises a valve disc 51, a valve barrel 52 extending upward from the valve disc 51, and a plunger 54 disposed in the valve barrel 52. The valve disc 51 is located between the hollow module 3 and the base 8, the valve barrel 52 is located in the hollow region 31, a receiving cavity 53 is defined in the valve barrel 52, and the plunger 54 is disposed in the receiving cavity 53. A valve inlet 55 is defined in the upper portion of the valve disc 51, a valve outlet 56 is defined in the lower portion of the valve disc 51, the valve inlet 55 is configured to communicate the second chamber 33 or the first chamber 32 with the receiving cavity 53, and the valve outlet 56 is configured to communicate the third chamber inlet 341 with the receiving cavity 53. An exhaust passage 57 penetrating the thickness thereof is further disposed on the valve disc 51, the exhaust passage 57 being in communication with the third chamber outlet 342.

A communication hole 61 is defined in the bottom of the first chamber 32, the communication hole 61 being a passage through which the first chamber 32 communicates with the rotary valve 5. The valve disc 51 of the rotary valve 5 rotates to communicate the valve inlet 55 with different communication holes 61, so as to suck the substance in the first chamber 32 into the receiving cavity 53, or to inject the substance in the receiving cavity 53 into the first chamber 32, and at the same time also to communicate the valve outlet 56 with different third chamber inlets 341 and the receiving cavity 53, or to communicate with the communication flow passage 12. In this embodiment, a communication tube 62 is disposed in the first chamber 32 corresponding to the communication hole 61, one end of the communication tube 62 is disposed in the communication hole 61, and the other end of the communication tube 62 extends into the first chamber 32. In this embodiment, the communication tube 62 is disposed at the communication hole 61, and the reagents in the first chamber 32 are drawn through the communication tube 62, thereby preventing the reagents from leaking downward through the communication hole 61 and causing contamination.

Specifically, the communication tube 62 comprises a first segment 71, a second segment 72 and a third segment 73 which are arranged in sequence; one end of the first segment 71 is inserted into the communication hole 61, the other end of the first segment 71 extends upward, the second segment 72 extends horizontally from the upper end of the first segment 71, and the third segment 73 extends downward from the second segment 72 and is close to the bottom of the first chamber 32. The first segment 71 and the third segment 73 are vertically arranged, wherein the first segment 71 is inserted into the communication hole 61, preventing the reagents from leaking downward through the communication hole 61, and the third segment 73 is close to the bottom of the first chamber 32 so as to draw the reagents in the first chamber 32.

All the communication holes 61 are located on the same circumference, and further, the projection of the third segment 73 on the horizontal plane is also located on this circumference. The communication holes 61 (this circumference) are correspondingly disposed at the lowest position within the first chamber 32, and the third segment 73 is also disposed corresponding to this lowest position, avoiding or reducing the residue of the reagents in the first chamber 32. The lower end nozzle of the third segment 73 is obliquely arranged, for allowing the substance in the first chamber 32 to enter the receiving cavity 53 through the obliquely arranged nozzle. The distance between the lower end of the third segment 73 and the bottom of the first chamber 32 is 0 mm, i.e., they are in contact, and at the same time, the substance in the first chamber 32 is drawn by means of the obliquely arranged lower end nozzle of the third segment 73.

The pressing assembly 210 in this embodiment comprises a fixed seat 219, pressing blocks (first pressing block 212 and second pressing block 214) and first drivers (first micro push rod 211 and second micro push rod 213), wherein one end of each pressing block is rotatably disposed on the fixed seat 219, the other end of the pressing block is configured to act on the kit 13, and the first driver is configured to drive the pressing block to rotate around the fixed seat 219. Two sets of the pressing assemblies 210 are respectively disposed on two sides of the conveying assembly 20, so that the force applied is more uniform, the fit between the kit 13 and the tray 2011, the first temperature control assembly 203 and the second temperature control assembly 204 is closer, the temperature control is more accurate, and the effect and accuracy of the reaction and detection are better.

The fully automatic testing apparatus comprises an isolation assembly 218 disposed corresponding to the isolation hole 131, configured to extend into the isolation hole 131 and squeeze the discharge tube 15 so as to close the passage between the fourth chamber and the fifth chamber 10. The isolation assembly 218 comprises a connecting block 216, an insertion head 217, and a second driver 215 for driving the insertion head 217 and the connecting block 216 to move; the insertion head 217 and the second driver 215 are respectively disposed on two sides of the connecting block 216, the insertion head 217 is configured to be inserted into the isolation hole 131 to squeeze the discharge tube 15, the connecting block 216 is configured in an annular shape, and the driving rod of the first driver (the second micro push rod 213) passes through the connecting block 216. The shape of the insertion head 217 is configured corresponding to the isolation hole 131. The cross-arrangement of the pressing assembly 210 and the isolation assembly 218, as well as the isolation assembly 218 being disposed directly below the image processing assembly 50, makes the structure more compact.

The tray assembly 201 comprises a tray 2011 and a bottom box 2012, the tray 2011 covers the bottom box 2012, the first temperature control assembly 203 and the second temperature control assembly 204 are independently and floatingly disposed in the bottom box 2012, and the tops of the first temperature control assembly 203 and the second temperature control assembly 204 pass through the tray 2011 and are respectively configured to contact the reaction zone (the base 8) and the chip zone of the kit 13.

The conveying assembly 20 corresponding to the tray assembly 201 comprises an eighth stepping motor 221, an eighth screw rod 222, an eighth slider 223, a first slide rail 225 and a second slide rail 226, wherein the first slide rail 225 and the second slide rail 226 are fixed below the bottom box 2012 and extend as the tray assembly 201 moves outward, and rollers are further disposed at the bottom of the tray assembly 201 to facilitate the extension of the tray assembly 201 out of the housing 601. When the user places the kit 13 on the tray 2011, the eighth stepping motor 221 rotates the eighth screw rod 222 to drive the eighth slider 223 to perform linear motion, wherein the first slide rail 225 and the second slide rail 226 can ensure the accuracy of the linear motion. When the tray 2011 moves to the set position (the plunger 54 and the center of the sleeve 324 are located on the same vertical line), the first micro push rod 211 and the second micro push rod 213 work simultaneously, respectively driving the first pressing block 212 and the second pressing block 214 to perform lever motion, and the first pressing block 212 and the second pressing block 214 will simultaneously press the side edges of the kit 13, so as to completely fit and fix it with the tray 2011, ensuring good contact between the kit 13 and the first temperature control assembly 203 as well as the second temperature control assembly 204, thereby ensuring the temperature control accuracy of the reaction inside the kit 13.

Based on the structure of the base 8 in the aforementioned kit 13, the first temperature control assembly 203 in this embodiment comprises a heating block 14, the heating block 14 extends into the round hole 81 and is in contact with the inner wall of the round hole 81, and the top of the heating block 14 is higher than the annular protrusion 83. The heating block 14 extends into the annular groove 82 and is in contact with the inner wall of the annular groove 82. In this embodiment, the sealing film 11 is configured in an annular shape so that the heating block 14 can extend into the round hole 81, and at the same time, by providing the annular protrusion 83 and the annular groove 82, and configuring the heating block 14 into a corresponding shape, the contact area between the base 8 and the heating block 14 is increased, thereby improving the heating effect and reaction speed and making the PCR amplification more efficient.

Specifically, the heating block 14 comprises a first extension portion 141, a step portion 143 and a second extension portion 142, wherein the first extension portion 141 extends into the round hole and reaches the annular protrusion 83, the top of the first extension portion 141 is higher than the annular protrusion 83, the step portion 143 is located below the annular protrusion 83, the second extension portion 142 extends into the annular groove 82, the first extension portion 141 and the step portion 143 are in contact with the inner wall of the round hole, and the second extension portion 142 is in contact with the inner wall of the annular groove 82.

In the kit 13 of the prior art, on the one hand, since the communication hole 61 at the bottom of the first chamber 32 is integrally formed by injection molding, its diameter is relatively large (about 1 mm); meanwhile, the valve disc 51 of the rotary valve 5 generates a slight negative pressure during rotation, and under the action of the gravity of the reagents and the negative pressure when the valve disc 51 rotates, the reagents will leak downward, and the leaked reagents will be carried by the valve disc 51 to other chambers, causing cross-contamination. On the other hand, the sealing film 11 of the existing kit 13 is complete, and the bottom surface of the base 8 corresponding to the third chamber 34 is a flat surface, such that the heating block 14 can only heat the third chamber 34 through the sealing film 11, resulting in unsatisfactory heating effect and low efficiency. In order to solve the above problems, in the kit 13 of this embodiment, on the one hand, a communication tube 62 is disposed in the first chamber 32, and the reagents are drawn through the communication tube 62, preventing the reagents from leaking downward through the communication hole 61 and causing contamination; on the other hand, the structures of the base 8 and the sealing film 11 are improved, thereby improving the heating effect.

In order to further improve the fit and floating effect between the first temperature control assembly 203, the second temperature control assembly 204 and the kit 13, a rod member 2050 extending toward the bottom box 2012 is disposed on the tray 2011, the first temperature control assembly 203 or the second temperature control assembly 204 is disposed on the rod member 2050, a limiting member 2052 is disposed at the bottom of the rod member 2050, an elastic member 2051 is sleeved on the rod member 2050, one end of the elastic member 2051 acts on the first temperature control assembly 203 or the second temperature control assembly 204, and the other end of the elastic member 2051 acts on the limiting member 2052. The above structure enables both the first temperature control assembly 203 and the second temperature control assembly 204 to be floatingly disposed on the tray 2011, and there is no connection structure between the first temperature control assembly 203 and the second temperature control assembly 204, which act independently and can better fit with the bottom of the kit 13 and control the temperature.

As to the first temperature control assembly 203 for the reaction zone, the core component is a reaction zone semiconductor cooler 2031, the non-working end of which is connected with a water cooling radiator 2032, the bottom of which is a water cooling radiator bottom plate 2033, and the working end of which is connected with a reaction zone thermally conductive block 2030, i.e., the heating block 14; the reaction zone thermally conductive block 2030 fits with the PCR reaction zone of the kit 13 and can rapidly heat or cool it. A temperature change rate ≥3 °C/second can be achieved, for example, a heating rate of 3.5 °C/second and a cooling rate of 3.2 °C/second, and the temperature is fed back and controlled by providing a platinum electrode temperature sensor.

As to the second temperature control assembly 204 for the chip zone, the core component is a chip zone semiconductor cooler 2041, the non-working end of which is connected with an air cooling radiator 2042, and the working end of which is connected with a chip zone thermally conductive block 2040; in cooperation with the platinum electrode temperature sensor and the control of the control assembly, the second temperature control assembly 204 can provide a constant temperature environment of set temperature ±0.1 °C, such as 37 °C±0.1 °C.

In this embodiment, the rod members 2050 are provided at the four corners of the water cooling radiator 2032 of the first temperature control assembly 203 and at the four corners of the air cooling radiator 2042 of the second temperature control assembly 204, ensuring that the temperature control assembly moves stably when the kit 13 presses down on the temperature control assembly and ensuring close fit between the two.

Corresponding to the first temperature control assembly 203, the base 8 of the reaction zone of the kit 13 is made of polycarbonate material, which is resistant to high temperature (greater than 100 °C); the surface of the detection chip 91 is fixed with a DNA probe array, and the bottom thereof has a silicon-based thermally conductive layer, wherein the high thermal conductivity coefficient of the silicon material ensures that heat can be rapidly and uniformly transferred to the DNA probe array on the upper surface, achieving efficient thermal coupling with the second temperature control assembly 204 and ensuring temperature uniformity. In this embodiment, the design in which the first temperature control assembly 203 focused on rapid temperature change (such as 96 °C, 8 seconds; 55 °C, 30 seconds; 72 °C, 5 seconds; with a heating/cooling rate ≥3 °C/second) and the second temperature control assembly 204 focused on high-precision constant temperature (such as 37 °C±0.1 °C) are independent and floating, avoiding temperature interference, and through the floating cooperation of the pressing assembly 210 pressing against the bottom of the kit 13, the temperature control effect is improved, and the rate of amplification reaction and the consistency of hybridization reaction are significantly improved.

Based on the structure of the kit 13 described above, the clamping assembly 30 of this embodiment comprises a clamping jaw and a first driving assembly for driving the clamping jaw to bring the plunger 54 to move. The rotation assembly 320 comprises a sleeve 324 and a second driving assembly for driving the sleeve 324 to rotate, wherein the sleeve 324 is configured to be sleeved on the valve barrel 52. The first driving assembly is configured to drive the plunger 54 to move so as to draw or inject substances, and the second driving assembly is configured to drive the valve barrel 52 and the valve disc 51 to rotate through the sleeve 324, so that the valve disc 51 corresponds to different chambers of the kit 13, and in cooperation with the movement of the plunger 54, substances are transferred between different chambers of the kit 13 or injected into the fourth chamber 92. A spring is disposed above the sleeve 324, which can achieve elastic compression; rotating in the state of elastic compression can achieve automatic alignment connection between the sleeve 324 and the valve barrel 52, and thus drive the rotation of the rotary valve 5 through the rotation of the sleeve 324.

In this embodiment, the second driving assembly comprises a third motor 321, a rotating hollow shaft 323, a fourth motor 331, a fourth screw rod 332 and a fourth slider 333, wherein a mounting bracket 322 is disposed on the fourth slider 333, and the rotating hollow shaft 323 is mounted to the mounting bracket 322. The fourth motor 331 rotates to cause the fourth screw rod 332 to drive the fourth slider 333 to move downward, and the fourth slider 333 is fixed together with the rotating hollow shaft 323 through the mounting bracket 322; through the downward movement of the fourth slider 333, the sleeve 324 is sleeved on the outer periphery of the valve barrel 52. The valve barrel 52 has an outer hexagonal structure, and the sleeve 324 has an inner hexagonal structure and has an elastic compression function. When the sleeve 324 is not angularly aligned with the valve barrel 52, the sleeve 324 will be compressed upward and has a tendency to move downward; at this time, the third motor 321 rotates to drive the sleeve 324 to rotate, and when the sleeve 324 is angularly aligned with the valve barrel 52, the sleeve 324 is sleeved on the outer periphery of the valve barrel 52 under the action of the downward elastic force. Then, the fourth slider 333 continues to move downward, descending until the upper half of the plunger 54 is above the rotating hollow shaft 323, so as to facilitate the subsequent clamping of the plunger 54 by the electric clamping jaw 304.

In this embodiment, the clamping jaw is an electric clamping jaw 304, and the first driving assembly comprises a first motor 301, a first screw 302, a first slider 303, a second motor 311, a second screw 312 and a second slider 313, wherein the electric clamping jaw is fixed on the first slider 303, the first motor 301 is fixed on the second slider 313, and the electric clamping jaw 304 together with the first motor 301, the first screw 302 and the first slider 303 are integrally moved by the second slider 313. The second motor 311 drives the second screw 312 to rotate, causing the second slider 313 to move downward to a suitable height. The first motor 301 and the first screw 302 fixed on the second slider 313 move synchronously, and then the first motor 301 drives the first screw 302 to rotate, causing the first slider 303 to move downward to near the height of the plunger 54, and then the electric clamping jaw 304 is actuated to clamp the plunger 54.

The third motor 321 rotates to drive the rotating hollow shaft 323 to rotate, and the sleeve 324 connected to the rotating hollow shaft 323 drives the valve barrel 52 to rotate. During the rotation of the valve barrel 52 and the valve disc 51, the laser sensor 3252 can identify the rotation angle of the valve disc 51; in cooperation with the motion data of the third motor 321 and the feedback signal of the laser sensor 3252, the accurate position of the valve disc 51 is identified, enabling it to be precisely aligned with different first chambers 32. Based on the action of the third motor 321, the valve barrel 52 can be aligned with different first chambers 32, and at the same time, the first motor 301 in combination with the electric clamping jaw 304 can cause the plunger 54 to accurately inject or draw liquid into or out of the first chamber 32; the combination of the two can achieve the transfer or mixing of the reagents in the first chamber 32. The same principle and process apply to the third chamber 34.

The image processing assembly 50 is located above the fourth chamber 92 and comprises an optical magnification objective lens 504 and its supporting coaxial optical path 503 and industrial camera 501. With the assistance of the light source 502, the industrial camera 501 can capture particles with a size of 1 μm on the detection chip. The image processing assembly 50 is driven to move by a focusing assembly to photograph and focus on the detection chip. The focusing assembly comprises a fifth motor 511 and a fifth slider 512 corresponding to movement in the horizontal direction (X direction) on the horizontal plane, a sixth motor 521 and a sixth slider 522 corresponding to movement in the vertical direction (Y direction) on the horizontal plane, and a seventh motor 531 and a seventh slider 532 corresponding to movement in the vertical direction (Z direction), wherein the sixth motor 521 is connected to the fifth slider 512, the seventh motor 531 is connected to the sixth slider 522, and the coaxial optical path 503 is connected to the seventh slider 532.

When the focusing assembly is in action, the fifth motor 511 drives the fifth slider 512 to provide high-precision displacement in the horizontal direction (X direction) on the horizontal plane. The sixth motor 521 drives the sixth slider 522 to provide high-precision displacement in the vertical direction (Y direction) on the horizontal plane. The seventh motor 531 drives the seventh slider 532 to provide movement in the vertical direction (Z direction), thereby achieving photographing and focusing of the detection chip by the industrial camera 501. In combination with the fifth slider 512 and the sixth slider 522, high-definition photographs of the reaction result area of the detection chip are taken, providing accurate and valid data for subsequent image processing. In this embodiment, the industrial camera 501, the coaxial optical path 503 and the optical magnification objective lens 504 are fixed on the seventh slider 532 in the Z direction, so that the center of the focusing assembly is closer to the optical path, which can greatly reduce the influence of vibration on imaging; under the premise of ensuring imaging accuracy, the image processing assembly can be disposed directly above the pressing assembly adjacent to the chip zone, further reducing the occupied space.

Meanwhile, in conventional hybridization chips, the target DNA and capture probes (capture DNA fragments complementary to the target DNA, which can be configured as multiplex detection targets, including pathogen-specific sequences or gene mutation sites) are passive and random, resulting in low hybridization efficiency and long required time. In this embodiment, it is further preferred that the detection chip 91 is an electric field-assisted microarray hybridization chip, which can accelerate the DNA hybridization process through electric field assistance. The electric field-assisted microarray hybridization chip is an existing detection biochip technology, such as the device and method for detecting nucleic acid in a biological sample disclosed in patent CN1867681A, or the biochip for biomolecular detection or sequencing and a manufacturing method thereof disclosed in patent CN106757376A, which will not be described in detail herein. With the adoption of the electric field-assisted microarray hybridization chip, the chip interface 202 is connected with the electrical contacts of the detection chip 91, and the chip interface 202 can provide voltage signals with adjustable waveform, amplitude and frequency, which act on the detection chip through the electrical contacts. By applying a specific electric field to accelerate the DNA hybridization process, the capture of DNA fragments is changed from passive and random to active capture, thereby accelerating the detection process and enhancing the detection capability for low-concentration samples.

In the fully automatic testing apparatus of the present disclosure, the two pressing assemblies 210 are correspondingly distributed on two sides of the tray assembly 201 and act on the four corners of the kit 13, so that the force applied and the force received are more uniform, and the fit between the kit 13 and the tray 2011 is closer; meanwhile, the first temperature control assembly 203 corresponding to the reaction zone and the second temperature control assembly 204 corresponding to the chip zone are independently and floatingly disposed on the tray assembly 201, so that the first temperature control assembly 203 and the reaction zone, and the second temperature control assembly 204 and the chip zone can more closely fit and act, improving the temperature control effect and ensuring the reaction accuracy and detection accuracy; the two independent pressing assemblies 210 and the independent floating temperature control assemblies can be applied to kits 13 of different specifications while ensuring the pressing and temperature control effects; the image processing assembly 50 is located directly above one of the pressing assemblies 210, making the overall structure more compact. The fully automatic testing apparatus can achieve the functions of tray conveying, amplification, multi-level temperature control management, automated reagent transfer and image analysis, solving the problems of cumbersome detection procedures, poor temperature control coordination and high risk of contamination from manual operation.

Based on the above kit 13 and fully automatic testing apparatus, the corresponding fully automatic testing method comprises the following steps:
Step 1: loading a sample into the kit 13; placing the kit 13 on the tray 2011, and the instrument automatically takes it in and locks the position.
Step 2: rotating and switching the rotary valve 5 to connect the second chamber 33, the first chamber 32 and the third chamber 34; driving the reagents to mix and distribute into the third chamber 34 by using the rotary valve 5 and the plunger 54, and starting the first temperature control assembly 203 to perform a nucleic acid amplification program to obtain an amplification product.
Step 3: transferring the amplification product into the fourth chamber, performing a hybridization reaction on the detection chip, capturing the target DNA fragments through electric field-assisted hybridization technology, and staining after constant temperature incubation.
Step 4: performing image acquisition and analysis on the reaction results of the detection chip through the image processing assembly 50, and outputting the detection results.
Step 5: the instrument releasing the fixation of the kit 13, and the kit 13 is sent out of the apparatus by the conveying assembly 20 of the kit 13, and the screen 603 displaying the analysis results.

With the assistance of the fully automatic testing apparatus, the kit 13 can automatically complete all experimental processes; the detection chip 91 of the kit 13 can capture the complementary pathogen target gene (DNA fragment), and by using an appropriate detection method (optical imaging), the pathogen target gene can be accurately quantified. During nucleic acid hybridization, the application of an electric field can accelerate the DNA hybridization process, changing the capture of DNA fragments from passive and random to active capture, thereby accelerating the detection process and enhancing the detection capability for low-concentration samples. For the detection process and detection method, reference may be made to, for example, patent CN114739996A, A Disposable Virus Detection Device; patent HK30118795A, An Integrated DNA Automatic Amplification and Detection Kit Device Integrating Pre-loaded Reagents and Nucleic Acid Hybridization Chip; patent CN117761050A, An Assay Cartridge Diagnostic Testing Apparatus; and patent HK30118796A, A Fully Automatic In Vitro Testing Instrument and Kit Integrated System Thereof, which will not be described in detail herein.

The present disclosure will now be described with reference to the various examples described hereinafter and various combinations of these examples.
1. One example provides a fully automatic testing apparatus, comprising:
a tray assembly, configured to carry a kit, wherein the kit comprises a reaction zone and a chip zone, the reaction zone is configured to perform amplification and obtain an amplification product, and the chip zone is configured to detect the amplification product;
pressing assemblies, two of the pressing assemblies being correspondingly distributed on two sides of the tray assembly, configured to press two sides of the kit against the tray assembly;
a first temperature control assembly, floatingly disposed in the tray assembly, configured to control the temperature of the reaction zone;
a second temperature control assembly, floatingly disposed in the tray assembly, configured to control the temperature of the chip zone; and
an image processing assembly, located above the pressing assembly adjacent to the chip zone, configured to acquire and analyze the detection results of the chip zone.
2. The fully automatic testing apparatus provided according to Example 1, wherein each of the pressing assemblies comprises a fixed seat, a pressing block and a first driver, wherein one end of the pressing block is rotatably disposed on the fixed seat, the other end of the pressing block is configured to act on the kit, and the first driver is configured to drive the pressing block to rotate around the fixed seat.
3. The fully automatic testing apparatus provided according to any one of the preceding examples, wherein the reaction zone of the kit comprises a first chamber for storing reagents, a second chamber for storing a sample, and a third chamber for providing a reaction site; the chip zone of the kit comprises a fourth chamber for detection and a fifth chamber for receiving waste liquid after detection, a discharge tube is disposed between the fourth chamber and the fifth chamber, and an isolation hole is disposed on a side edge of the kit corresponding to the discharge tube; the fully automatic testing apparatus comprises an isolation assembly disposed corresponding to the isolation hole, configured to extend into the isolation hole and squeeze the discharge tube so as to close the passage between the fourth chamber and the fifth chamber.
4. The fully automatic testing apparatus provided according to any one of the preceding examples, wherein the isolation assembly comprises a connecting block, an insertion head, and a second driver for driving the insertion head and the connecting block to move, wherein the insertion head and the second driver are respectively disposed on two sides of the connecting block, the insertion head is configured to be inserted into the isolation hole to squeeze the discharge tube, the connecting block is configured in an annular shape, and a driving rod of the first driver passes through the connecting block.
5. The fully automatic testing apparatus provided according to any one of the preceding examples, wherein the tray assembly comprises a tray and a bottom box, the tray covers the bottom box, the first temperature control assembly and the second temperature control assembly are disposed in the bottom box, and the tops of the first temperature control assembly and the second temperature control assembly pass through the tray and are respectively configured to contact the reaction zone and the chip zone of the kit, wherein the bottom of the chip zone has a silicon-based thermally conductive layer for contacting the second temperature control assembly.
6. The fully automatic testing apparatus provided according to any one of the preceding examples, wherein a rod member extending toward the bottom box is disposed on the tray, the first temperature control assembly or the second temperature control assembly is disposed on the rod member, a limiting member is disposed at the bottom of the rod member, an elastic member is sleeved on the rod member, one end of the elastic member acts on the first temperature control assembly or the second temperature control assembly, and the other end of the elastic member acts on the limiting member.
7. The fully automatic testing apparatus provided according to any one of the preceding examples, wherein the kit comprises a rotary valve, the rotary valve comprises a valve disc and a valve barrel extending upward from the valve disc, a receiving cavity is defined in the valve barrel, and a plunger is disposed in the receiving cavity; the fully automatic testing apparatus comprises a clamping assembly for clamping the plunger and driving the plunger to move, and a rotation assembly for clamping the valve barrel and driving the valve barrel and the valve disc to rotate.
8. The fully automatic testing apparatus provided according to any one of the preceding examples, wherein the clamping assembly comprises a clamping jaw and a first driving assembly for driving the clamping jaw to bring the plunger to move; the rotation assembly comprises a sleeve and a second driving assembly for driving the sleeve to rotate, wherein the sleeve is configured to be sleeved on the valve barrel.
9. The fully automatic testing apparatus provided according to any one of the preceding examples, wherein a valve inlet is defined in the upper portion of the valve disc, a valve outlet is defined in the lower portion of the valve disc, the valve inlet is configured to communicate the second chamber or the first chamber with the receiving cavity, and the valve outlet is configured to communicate the third chamber with the receiving cavity.
10. The fully automatic testing apparatus provided according to any one of the preceding examples, wherein a communication hole is defined in the bottom of the first chamber, and the valve disc of the rotary valve rotates to communicate the valve inlet with the communication hole, so as to suck the substance in the first chamber into the receiving cavity, or to inject the substance in the receiving cavity into the first chamber.
11. The fully automatic testing apparatus provided according to any one of the preceding examples, wherein a communication tube is disposed in the first chamber corresponding to the communication hole, one end of the communication tube is disposed in the communication hole, and the other end of the communication tube extends into the first chamber.
12. The fully automatic testing apparatus provided according to any one of the preceding examples, wherein the communication tube comprises a first segment, a second segment and a third segment which are arranged in sequence, one end of the first segment is inserted into the communication hole, the other end of the first segment extends upward, the second segment extends horizontally from the upper end of the first segment, and the third segment extends downward from the second segment and is close to the bottom of the first chamber.
13. The fully automatic testing apparatus provided according to any one of the preceding examples, wherein the distance between the lower end of the third segment and the bottom of the first chamber is 0-1 mm.
14. The fully automatic testing apparatus provided according to any one of the preceding examples, wherein the kit comprises a plurality of communication holes, all of the communication holes are located on the same circumference, and the projection of the third segment on the horizontal plane is located on the circumference.
15. The fully automatic testing apparatus provided according to any one of the preceding examples, wherein the lower end nozzle of the third segment is obliquely arranged, for allowing the substance in the first chamber to enter the receiving cavity through the communication tube.
16. The fully automatic testing apparatus provided according to any one of the preceding examples, wherein the kit comprises a base, the base being configured to contact the first temperature control assembly; the third chamber is disposed in the base, a sealing film is disposed on the bottom surface of the base corresponding to the third chamber, and the sealing film is configured to seal the bottom of the third chamber.
17. The fully automatic testing apparatus provided according to any one of the preceding examples, wherein a round hole is defined in a center of the base and in a center of the sealing film, an annular protrusion extending toward the interior of the round hole is provided on the inner wall of the round hole, the first temperature control assembly comprises a heating block, the heating block comprises a first extension portion extending into the round hole and reaching the annular protrusion and a step portion located below the annular protrusion, the first extension portion and the step portion contact the inner wall of the round hole, and the top of the first extension portion is higher than the annular protrusion.
18. The fully automatic testing apparatus provided according to any one of the preceding examples, wherein an annular groove is provided at the bottom of the base outside the third chamber, the heating block comprises a second extension portion extending into the annular groove, and the second extension portion contacts the inner wall of the annular groove.
19. The fully automatic testing apparatus provided according to any one of the preceding examples, wherein the fully automatic testing apparatus comprises a housing, the housing has an opening for allowing the tray assembly to move out of the housing, and the housing comprises a cover plate covering the opening.
20. The fully automatic testing apparatus provided according to any one of the preceding examples, wherein the fully automatic testing apparatus comprises a control assembly and a screen disposed on the housing, the control assembly is connected with the screen and each assembly, and the screen is operated to control the action of each assembly through the control assembly.

Finally, it should be noted that the above embodiments are only used to illustrate the technical solutions of the present disclosure and not to limit them. Although the present disclosure has been described in detail with reference to the above embodiments, those of ordinary skill in the art should understand that modifications or equivalent replacements can still be made to the specific embodiments of the present disclosure, and any modifications or equivalent replacements that do not depart from the spirit and scope of the present disclosure shall be covered within the protection scope of the claims of the present disclosure.

What is claimed is:

1. A fully automatic testing apparatus, comprising:
a tray assembly, configured to carry a kit, wherein the kit comprises a reaction zone and a chip zone, the reaction zone is configured to perform amplification and obtain an amplification product, and the chip zone is configured to detect the amplification product;
pressing assemblies, two of the pressing assemblies being correspondingly distributed on two sides of the tray assembly, configured to press two sides of the kit against the tray assembly; wherein each of the pressing assemblies comprises a fixed seat, a pressing block and a first driver, wherein one end of the pressing block is rotatably disposed on the fixed seat, the other end of the pressing block is configured to act on the kit, and the first driver is configured to drive the pressing block to rotate around the fixed seat;
a first temperature control assembly, floatingly disposed in the tray assembly, configured to control the temperature of the reaction zone;
a second temperature control assembly, floatingly disposed in the tray assembly, configured to control the temperature of the chip zone; and
an image processing assembly, located above the pressing assembly adjacent to the chip zone, configured to acquire and analyze the detection results of the chip zone.

2. The fully automatic testing apparatus according to claim 1, wherein the reaction zone of the kit comprises a first chamber for storing reagents, a second chamber for storing a sample, and a third chamber for providing a reaction site; the chip zone of the kit comprises a fourth chamber for detection and a fifth chamber for receiving waste liquid after detection, a discharge tube is disposed between the fourth chamber and the fifth chamber, and an isolation hole is disposed on a side edge of the kit corresponding to the discharge tube; the fully automatic testing apparatus comprises an isolation assembly disposed corresponding to the isolation hole, configured to extend into the isolation hole and squeeze the discharge tube so as to close the passage between the fourth chamber and the fifth chamber.

3. The fully automatic testing apparatus according to claim 2, wherein the isolation assembly comprises a connecting block, an insertion head, and a second driver for driving the insertion head and the connecting block to move, wherein the insertion head and the second driver are respectively disposed on two sides of the connecting block, the insertion head is configured to be inserted into the isolation hole to squeeze the discharge tube, the connecting block is configured in an annular shape, and a driving rod of the first driver passes through the connecting block.

4. The fully automatic testing apparatus according to claim 1, wherein the tray assembly comprises a tray and a bottom box, the tray covers the bottom box, the first temperature control assembly and the second temperature control assembly are disposed in the bottom box, and the tops of the first temperature control assembly and the second temperature control assembly pass through the tray and are respectively configured to contact the reaction zone and the chip zone of the kit, wherein the bottom of the chip zone has a silicon-based thermally conductive layer for contacting the second temperature control assembly.

5. The fully automatic testing apparatus according to claim 4, wherein a rod member extending toward the bottom box is disposed on the tray, the first temperature control assembly or the second temperature control assembly is disposed on the rod member, a limiting member is disposed at the bottom of the rod member, an elastic member is sleeved on the rod member, one end of the elastic member acts on the first temperature control assembly or the second temperature control assembly, and the other end of the elastic member acts on the limiting member.

6. The fully automatic testing apparatus according to claim 2, wherein the kit comprises a rotary valve, the rotary valve comprises a valve disc and a valve barrel extending upward from the valve disc, a receiving cavity is defined in the valve barrel, and a plunger is disposed in the receiving cavity; the fully automatic testing apparatus comprises a clamping assembly for clamping the plunger and driving the plunger to move, and a rotation assembly for clamping the valve barrel and driving the valve barrel and the valve disc to rotate.

7. The fully automatic testing apparatus according to claim 6, wherein the clamping assembly comprises a clamping jaw and a first driving assembly for driving the clamping jaw to bring the plunger to move; the rotation assembly comprises a sleeve and a second driving assembly for driving the sleeve to rotate, wherein the sleeve is configured to be sleeved on the valve barrel.

8. The fully automatic testing apparatus according to claim 6, wherein a valve inlet is defined in the upper portion of the valve disc, a valve outlet is defined in the lower portion of the valve disc, the valve inlet is configured to communicate the second chamber or the first chamber with the receiving cavity, and the valve outlet is configured to communicate the third chamber with the receiving cavity.

9. The fully automatic testing apparatus according to claim 8, wherein a communication hole is defined in the bottom of the first chamber, and the valve disc of the rotary valve rotates to communicate the valve inlet with the communication hole, so as to suck the substance in the first chamber into the receiving cavity, or to inject the substance in the receiving cavity into the first chamber.

10. The fully automatic testing apparatus according to claim 9, wherein a communication tube is disposed in the first chamber corresponding to the communication hole, one end of the communication tube is disposed in the communication hole, and the other end of the communication tube extends into the first chamber.

11. The fully automatic testing apparatus according to claim 10, wherein the communication tube comprises a first segment, a second segment and a third segment which are arranged in sequence, one end of the first segment is inserted into the communication hole, the other end of the first segment extends upward, the second segment extends horizontally from the upper end of the first segment, and the third segment extends downward from the second segment and is close to the bottom of the first chamber.

12. The fully automatic testing apparatus according to claim 11, wherein the distance between the lower end of the third segment and the bottom of the first chamber is 0-1 mm.

13. The fully automatic testing apparatus according to claim 11, wherein the kit comprises a plurality of communication holes, all of the communication holes are located on the same circumference, and the projection of the third segment on the horizontal plane is located on the circumference.

14. The fully automatic testing apparatus according to claim 11, wherein the lower end nozzle of the third segment is obliquely arranged, for allowing the substance in the first chamber to enter the receiving cavity through the communication tube.

15. The fully automatic testing apparatus according to claim 2, wherein the kit comprises a base, the base being configured to contact the first temperature control assembly; the third chamber is disposed in the base, a sealing film is disposed on the bottom surface of the base corresponding to the third chamber, and the sealing film is configured to seal the bottom of the third chamber.

16. The fully automatic testing apparatus according to claim 15, wherein a round hole is defined in a center of the base and in a center of the sealing film, an annular protrusion extending toward the interior of the round hole is provided on the inner wall of the round hole, the first temperature control assembly comprises a heating block, the heating block comprises a first extension portion extending into the round hole and reaching the annular protrusion and a step portion located below the annular protrusion, the first extension portion and the step portion contact the inner wall of the round hole, and the top of the first extension portion is higher than the annular protrusion.

17. The fully automatic testing apparatus according to claim 16, wherein an annular groove is provided at the bottom of the base outside the third chamber, the heating block comprises a second extension portion extending into the annular groove, and the second extension portion contacts the inner wall of the annular groove.

18. The fully automatic testing apparatus according to claim 1, comprising a housing, wherein the housing has an opening for allowing the tray assembly to move out of the housing, and the housing comprises a cover plate covering the opening.

19. The fully automatic testing apparatus according to claim 18, comprising a control assembly and a screen disposed on the housing, wherein the control assembly is connected with the screen and each assembly, and the screen is operated to control the action of each assembly through the control assembly.
